(19) United States
(12) Patent Application Publication
(10) Pub. No.: US 2025/0004677 A1
(43) Pub. Date: Jan. 2, 2025

(54) INFORMATION PROCESSING APPARATUS, CONTROL METHOD, AND RECORDING MEDIUM

(71) Applicant: CANON KABUSHIKI KAISHA, Tokyo (JP)

(72) Inventor: AKIHIRO YASUDA, Saitama (JP)

(21) Appl. No.: 18/750,911

(22) Filed: Jun. 21, 2024

(30) Foreign Application Priority Data
Jun. 27, 2023 (JP) 2023-104675

(51) Int. Cl. G06F 3/12

(52) U.S. Cl. CPC G06F 3/1228; G06F 3/1205; G06F 3/1231; G06F 3/1287

(57) ABSTRACT

A non-transitory computer-readable recording medium stores a program that causes a computer to perform a method for controlling an information processing apparatus storing a plurality of universal printer drivers. The method includes receiving a plurality of icon images each identified based on identification information of a printer, selecting one icon image from among the plurality of icon images based on the type of universal printer driver stored in association with the identification information of the printer, and controlling displaying of the selected icon image on a display unit.

### BACKGROUND

### Field of the Disclosure

The present disclosure relates to information processing apparatus, a control method, and a recording medium.

### Description of the Related Art

For existing printers, printing has been performed by drivers provided by printer vendors (printer manufacturers). In recent years, universal printer drivers provided by OS manufacturers are available to print without using a driver provided by the printer vendor. For example, Windows (registered trademark) comes with a universal printer driver called IPP Class Driver, and Android (registered trademark) comes with a universal printer driver called Mopria (registered trademark). In addition, iOS (registered trademark) comes with a universal printer driver called AirPrint (registered trademark) as a function of the OS. These universal printer drivers are drivers that send print commands in compliance with a printing protocol called IPP (Internet Printing Protocol). Therefore, printers that support IPP can receive such print commands and perform printing. These universal printer drivers are characterized in that they can perform printing on a plurality of models of printers from a plurality of printer vendors that support the printing protocol.

However, using a universal printer driver may be inconvenient because the driver cannot support vendor specific functions and cannot be used or because the OS cannot distinguish between printers from different vendors and displays the same icons.

Japanese Patent Laid-Open No. 2022-89143 describes that even when a standard printer driver is used, the icon image can be acquired from the printer or a cloud print service and, thus, the icon image can be displayed.

Some information processing apparatuses may each include two universal printer drivers, one for cloud print and the other for local connection. Therefore, if the icon image is model-specific, the same icon images are displayed for the above-described two universal printer drivers.

### SUMMARY

Accordingly, embodiments of the present disclosure provide a computer program that performs a user-friendly control method for a user to control an information processing apparatus.

According to embodiments of the present disclosure, a non-transitory computer-readable recording medium stores one or more control programs including executable instructions, which when executed by a computer, cause a computer to perform a method for controlling an information processing apparatus storing a plurality of universal printer drivers. The method includes receiving a plurality of icon images each identified based on identification information of a printer, selecting one icon image from among the plurality of icon images based on the type of universal printer driver stored in association with the identification information of a printer, and controlling displaying of the selected icon image on a display unit.

Further features of the present disclosure will become apparent from the following description of exemplary embodiments with reference to the attached drawings.

### BRIEF DESCRIPTION OF THE DRAWINGS

FIG. 1 illustrates an example of a network configuration according to the present embodiment.

FIGS. 2A to 2E illustrate examples of hardware configurations according to the present embodiment.

FIG. 3 is a sequence diagram from the time an extension application is installed to the time the icon image is placed, according to the present embodiment.

FIGS. 4A and 4B illustrate examples of screens that are related to a printer to be used and that are displayed by an OS according to the present embodiment.

FIGS. 5A to 5C illustrate examples of icon images according to the present embodiment.

FIGS. 6A and 6B illustrate an example of pieces of information that make up device capability information according to the present embodiment.

FIGS. 7A and 7B illustrate an example of pieces of information that make up an extended setup information file according to the present embodiment.

FIG. 8 illustrates an example of a user interface (UI) in which a print setting extension application displays an icon image for each of queues according to the present embodiment.

FIG. 9 is a flowchart of an example of the process performed by the print setting extension application to acquire an icon image, according to the present embodiment.

FIG. 10 is a flowchart of an example of the process performed by an OS to display an icon image, according to the present embodiment.

FIG. 11 illustrates an example of a screen for displaying the path of an icon image held by the OS according to the present embodiment.

FIG. 12 illustrates an example of a file system managed by an online support service according to the present embodiment.

FIG. 13 illustrates an example of a sequence of processes performed when a printer and a client terminal are connected according to the present embodiment.

FIG. 14 is a schematic illustration of an example of the printing process using the print setting extension application according to the present embodiment.

FIG. 15 illustrates an example of a print setting screen provided by a file generation application according to the present embodiment.

FIG. 16 illustrates an example of the print setting screen displayed by the print setting extension application according to the present embodiment.

FIG. 17 illustrates another example of the extended setup information file according to the present embodiment.

FIG. 18 illustrates an example of a screen displaying the properties of a print queue provided by the OS according to the present embodiment.

FIGS. 19A and 19B illustrate an example of the process performed when the OS generates a print queue and displays an icon image according to the present embodiment.

### DESCRIPTION OF THE EMBODIMENTS

Embodiments of the present disclosure are described below with reference to the accompanying drawings.

### First Embodiment

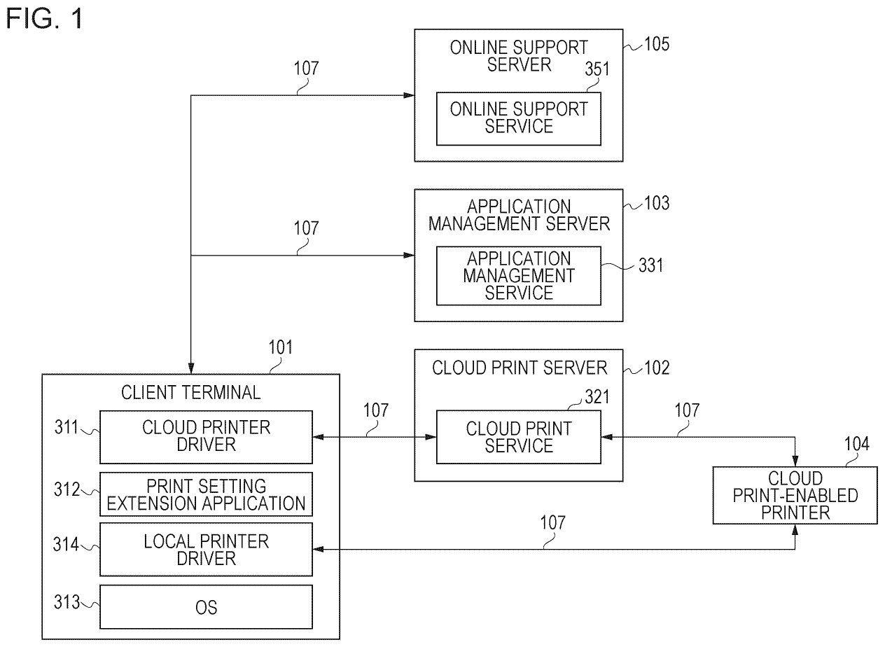

FIG. 1 is a configuration diagram of a printing system related to cloud print according to the present embodiment. A network 107 connects a client terminal 101, a cloud print server 102, an application management server 103, a cloud print-enabled printer 104, a printer 106, and an online support server 105.

In FIG. 1, one client terminal 101 and one cloud print-enabled printer 104 are illustrated. However, there may be a plurality of client terminals 101 and a plurality of cloud print-enabled printers 104.

Each of the cloud print server 102, the application management server 103, and the online support server 105 may be a server system consisting of a plurality of information processing apparatuses. A server system consisting of a plurality of information processing apparatuses can distribute the load to the plurality of information processing apparatuses.

The cloud print server 102, the application management server 103, and the online support server 105 may be virtually configured inside of a single physical information processing apparatus.

According to the present embodiment, the network 107 is a wide area network (WAN), such as the Internet, for connection to a cloud service. However, a closed network environment for all the nodes, such as a corporate LAN, may be employed.

The client terminal 101 is an information processing apparatus, such as a personal computer (PC), a tablet, or a smartphone, which is directly operated by a user. Any application software can be executed on the client terminal 101.

The cloud print-enabled printer 104 is an apparatus that actually prints on a recording medium, such as paper, and is an image forming apparatus that converts print data received via the network 107 into image data for printing. The hardware configuration of the printer 106 is similar to that of the cloud print-enabled printer 104.

The printer 106 is connected to the client terminal 101 for communication without using a cloud print service 321. The client terminal 101 uses a cloud printer driver 311 and generates print data to be sent to the cloud print-enabled printer 104 via the cloud print service 321. The client terminal 101 uses a local printer driver 314 and generates print data to be sent to printer 106.

The design may be such that the cloud print-enabled printer 104 may receive and print the print data generated by the local printer driver 314 without using the cloud print service 321. In addition, the design may be such that the printer 106 may receive the print data generated by the cloud printer driver 311 via the cloud print service 321.

The cloud print server 102 receives a print instruction and print data from the outside. The cloud print server 102 then sends the received print data to the cloud print-enabled printer 104.

The application management server 103 holds and manages a variety of applications.

The application management server 103 receives the identification information of an application and a download request from the client terminal 101 and sends the application identified based on the received identification information to the client terminal 101.

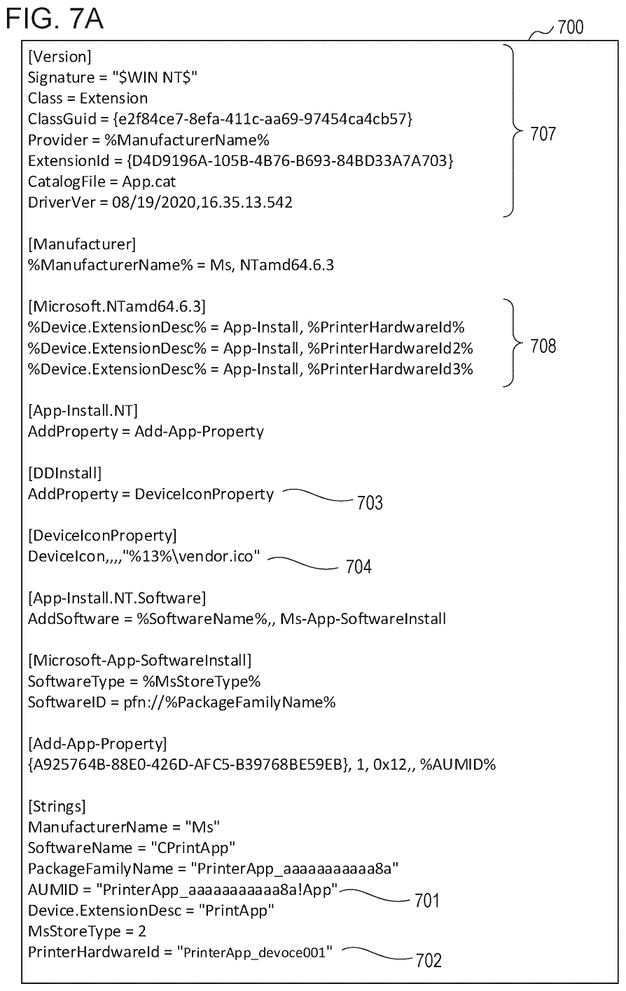

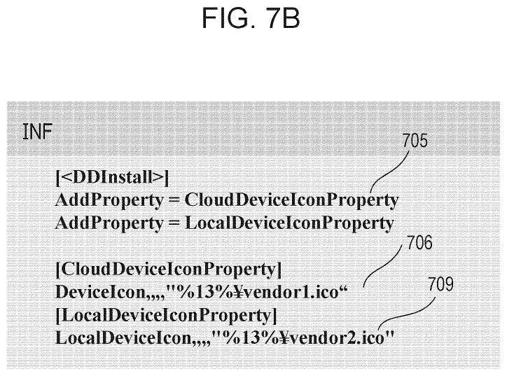

The online support server 105 is a server that provides an online support service 351. The online support service 351 is a service for providing, to the client terminal 101, a file that contains information for enhancing the functionality of the client terminal 101. A vendor (manufacturer) that provides the cloud print-enabled printer 104 or the printer 106 registers, to the online support service 351, the information for enhancing the print function provided by the operating system of the client terminal 101 in advance. FIG. 12 illustrates an extended setup information file name 1201 and icon image names 1202 and 1203 that are registered to the online support service 351 by the vendor that provides the printer. The extended setup information file name 1201 is the name of an extended setup information file 700 illustrated in FIG. 7A. The icon image names 1202 and 1203 are the names of icon image data to be stored in association with a print queue when the client terminal 101 installs the extended setup information file 700.

The client terminal 101 stores the cloud printer driver 311, a print setting extension application 312, a local printer driver 314, and an OS 313. The cloud printer driver 311, the print setting extension application 312, the local printer driver 314, and the OS 313 which are executed by a central processing unit (CPU) 212 of the client terminal 101, are all computer programs. The cloud printer driver 311, the local printer driver 314, and the OS 313 are installed on the client terminal 101 before the client terminal 101 is shipped out. The print setting extension application 312 is acquired from the application management server 103 in response to a user operation after shipment of the client terminal 101 and is stored in a storage unit 214 of the client terminal 101.

Both of the cloud printer driver 311 and local printer driver 314 are universal printer drivers that generate print data consisting of image data and attribute values, which correspond to print settings, to be transmitted over IPP. By using IPP, which is a general-purpose protocol, the cloud printer driver 311 and the local printer driver 314 generate print data that can be printed on a plurality of models of printers from different printer vendors.

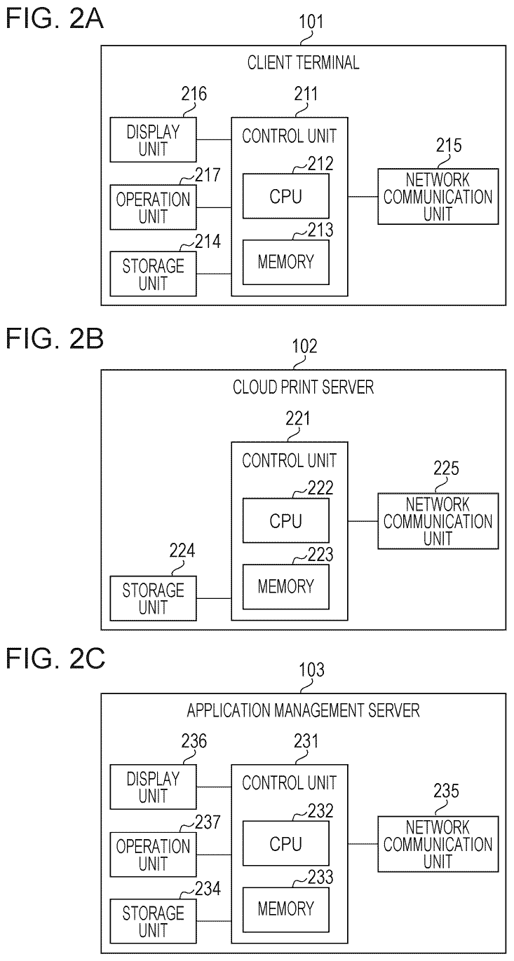

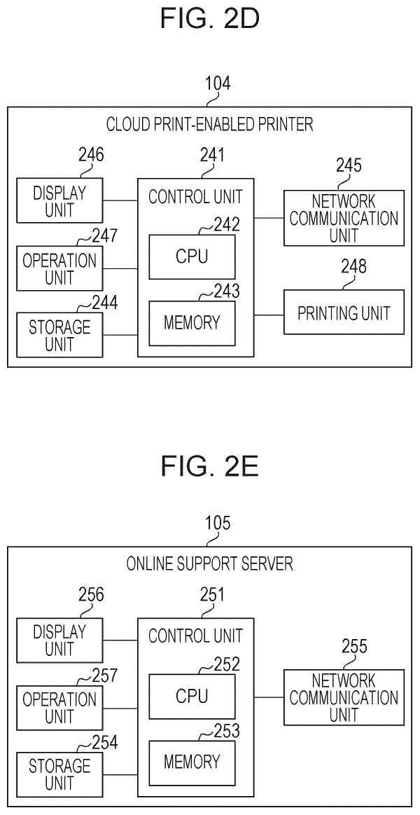

The hardware configuration of the system according to the present embodiment is described below with reference to FIGS. 2A to 2E.

FIG. 2A is a block diagram of an example of the hardware configuration of the client terminal 101.

The client terminal 101 includes a display unit 216, an operation unit 217, the storage unit 214, a control unit 211, and a network communication unit 215.

The storage unit 214 is a nonvolatile storage unit, such as a hard disk drive (HDD) or a solid-state drive (SSD), which can store and rewrite digital data.

The control unit 211 includes the CPU 212 and a memory 213. The control unit 211 performs overall control of the operations performed by the client terminal 101. The CPU 212 loads programs stored in the storage unit 214 into the memory 213 and executes the loaded programs. The memory 213 is the main memory of the CPU 212 and is used as a work area and a temporary storage area for loading a variety of programs.

The network communication unit 215 is a unit that communicates with the network 107 that is external and performs input/output of digital data to and from an external server, a client terminal, and the like via the network 107.

The display unit 216 is a unit for displaying visual information for a user in real time (for example, an LCD display). The operation unit 217 is a unit for receiving an input from the user using, for example, a keyboard, mouse, or other device. A touch panel or other device that functions as both the display unit 216 and operation unit 217 may be used.

FIG. 2B is a block diagram of an example of the hardware configuration of the cloud print server 102. The cloud print server 102 includes a storage unit 224, a control unit 221, and a network communication unit 225.

Descriptions of the storage unit 224, the control unit 221, and the network communication unit 225 are the same as those for the client terminal 101 and are omitted.

The cloud print server 102 is described below that consists of a single information processing apparatus having the hardware configuration illustrated in FIG. 2B. However, the cloud print server 102 may be configured with a plurality of information processing apparatuses each illustrated in FIG. 2B.

FIG. 2C is a block diagram of an example of the hardware configuration of the application management server 103. The application management server 103 includes a display unit 236, an operation unit 237, a storage unit 234, a control unit 231, and a network communication unit 235.

Descriptions of the display unit 236, the operation unit 237, the storage unit 234, the control unit 231, and the network communication unit 235 are the same as those for the client terminal 101 and are, therefore, omitted.

The application management server 103 consisting of a single information processing apparatus having the hardware configuration illustrated in FIG. 2C is described below. However, the application management server 103 may be configured with a plurality of information processing apparatuses.

FIG. 2D is a block diagram of an example of the hardware configuration of the cloud print-enabled printer 104. The cloud print-enabled printer 104 includes a display unit 246, an operation unit 247, a storage unit 244, a control unit 241, a network communication unit 245, and a printing unit 248.

The display unit 246 is a unit, such as a touch panel or an LED, provided in the cloud print-enabled printer 104 for displaying information to a user in real time.

The operation unit 247 is a unit for receiving an input from the user. The operation unit 247 may include hard keys, such as a numeric keypad, in addition to a touch panel. The storage unit 244 and the control unit 241 are similar to those of the client terminal 101, and descriptions thereof are therefore omitted.

The network communication unit 245 is a unit that communicates with the network 107 that is external and is mainly responsible for receiving print data and transmitting information about the status of the cloud print-enabled printer 104, such as an error status, to an external server or other devices.

The printing unit 248 is a unit that performs a printing process, that is, performs a series of feeding, printing, and discharge operations on paper prestored in a cassette or tray. The printing method is not limited to electrophotographic or inkjet printing. The printing unit 248 also includes a duplex printing unit used when outputting paper, as well as a finishing unit for stapling and punching.

According to the present embodiment, a single function printer that performs only a print function is described as an example of a cloud print-enabled printer 104. However, a multi-function printer that further has scanner and fax functions may also be used.

The hardware configuration of the printer 106 illustrated in FIG. 1 is also the same as in FIG. 2D.

FIG. 2E is a hardware block diagram of an example of the online support server 105. According to the present embodiment, the online support server 105 consisting of a single information processing apparatus is described below. However, the online support server 105 may consist of a plurality of information processing apparatuses. The online support server 105 includes a display unit 256, an operation unit 257, a storage unit 254, a control unit 251, and a network communication unit 255. The display unit 256 and the operation unit 257 are similar to the display unit 216 and the operation unit 217 of the client terminal 101, respectively, and thus are omitted from the description. The storage unit 254 is a memory device, such as an HDD or SSD. The storage unit 254 stores a file containing information used to enhance the functions provided by the client terminal 101.

The control unit 251 includes a CPU 252 and a memory 253. The CPU 252 performs overall control of the online support server 105. The memory 253 is used for processing performed by the CPU 252. The network communication unit 255 is an interface used for the online support server 105 to communicate with the client terminal 101. The online support server 105 receives a request to acquire a file stored in the storage unit 254 and sends the corresponding file to the client terminal 101 via the network communication unit 255.

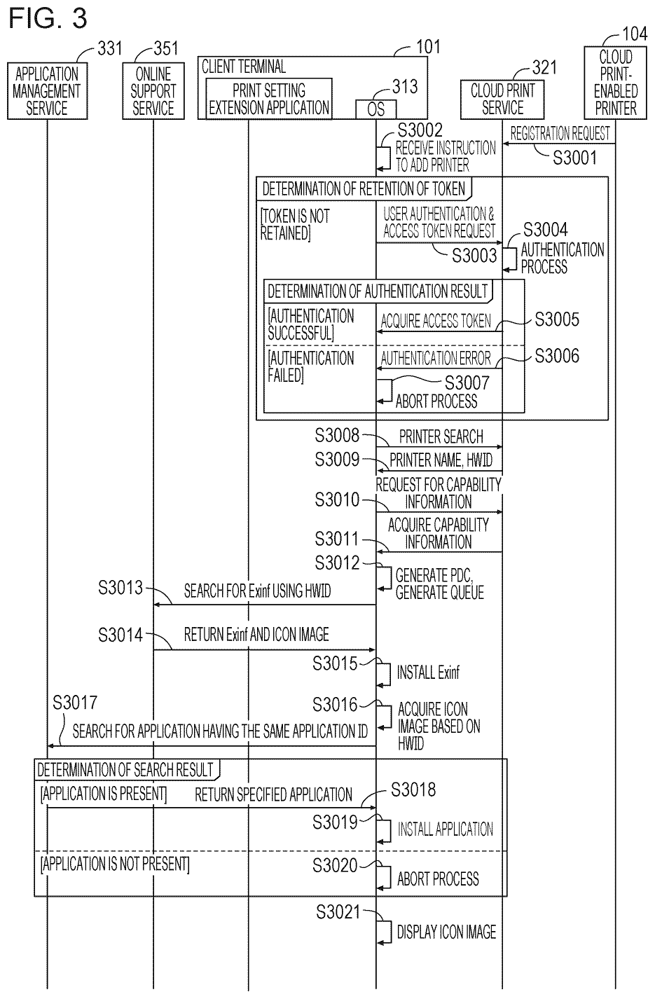

An example of the sequence for the user operation and the sequence for processes performed between a software module and the print service according to the present embodiment are described below with reference to FIG. 3. In the present example, the cloud print-enabled printer 104 is registered to the cloud print service 321, and an icon is acquired using the cloud print service 321.

The cloud print-enabled printer 104 first receives a printer registration operation from a user to register the cloud print-enabled printer 104 to the cloud print service 321. In response to the printer registration operation, the cloud print-enabled printer 104 sends the device identification information of the printer and a printer registration request to the cloud print service 321 (S3001). The device identification information sent to the cloud print service 321 is, for example, a hardware ID (HWID) assigned to each of printer models.

The device identification information may be any information that can identify the printer model.

Upon receiving the registration request, the cloud print service 321 sends the printer registration URL of the cloud print service 321 to the cloud print-enabled printer 104. The user accesses the URL from the cloud print-enabled printer 104 or the information processing apparatus, inputs a user ID and a password for using the cloud print service 321, and logs in to the cloud print service 321. If the user's login is successful, the cloud print service 321 sends, to the cloud print-enabled printer 104, a request for acquiring the information necessary to register the printer. In response to the request, the cloud print-enabled printer 104 sends the printer information to the cloud print service 321.

Subsequently, the cloud print service 321 registers the information about the cloud print-enabled printer 104 and generates a print queue for the cloud print-enabled printer 104. At this time, the cloud print service 321 acquires the capability information of the cloud print-enabled printer 104 and associates the capability information with the generated print queue. As used herein, the term “capability information” refers to information that represents the functions of the printer and that is necessary for the user to configure the print settings when printing, such as duplex printing capability information, color printing capability information, and stapling capability information. More specifically, as a particular example, IPP is used as the communication protocol. The cloud print-enabled printer 104 sends the capability information to the cloud print service 321 using the attribute values defined in IPP. An attribute value that is not defined in IPP is directly sent to the cloud print service 321.

Installation of the print setting extension application 312 is described below. The installation is performed when the user uses the client terminal 101 and performs a setup operation for printing using the cloud print-enabled printer 104.

The OS 313 of the client terminal 101 receives a cloud print-enabled printer setup operation performed by the user. The cloud print-enabled printer setup operations include, for example, the operations described below.

The OS 313 of the client terminal 101 receives, from the user, an instruction to add a printer (S3002).

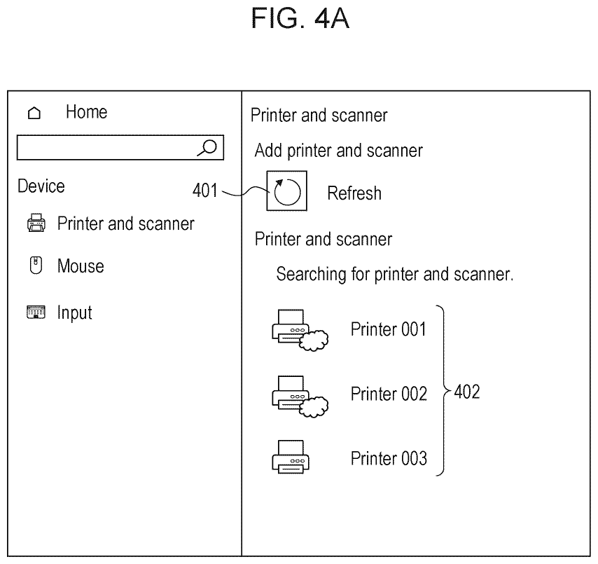

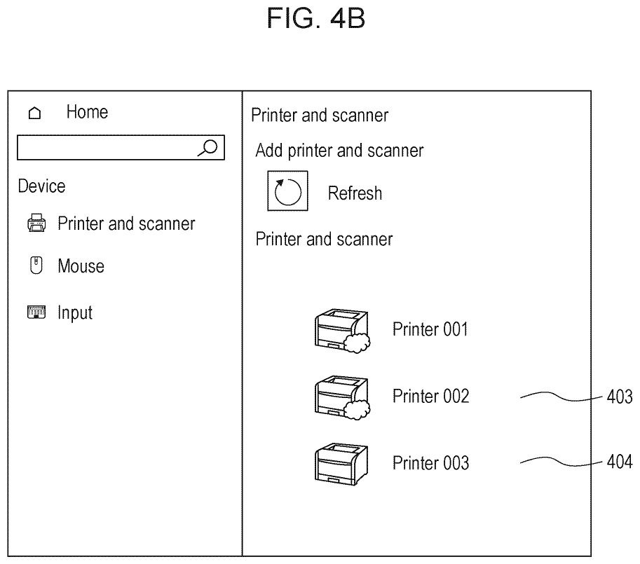

FIGS. 4A and 4B illustrate screens displayed by the OS 313 of the client terminal 101 to manage information regarding a print queue registered in the OS 313 of the client terminal 101. The user selects an object 401 to input a printer search instruction to the OS 313.

Upon receiving the printer search instruction, the OS 313 determines whether to hold a token to acquire information from the cloud print service 321.

If the OS 313 does not hold the token, the OS 313 displays a screen for the user to input user information (a login name and a password). The user information input via the screen is sent to the cloud print service 321 to request user authentication and an access token (S3003).

The cloud print service 321 performs an authentication process by using the user information received from the client terminal 101 (S3004). When the authentication process is completed, the cloud print service 321 notifies the client terminal 101 of the result of the authentication process.

If the user authentication is successful, the OS 313 acquires an access token from the cloud print service 321 (S3005).

If, in S3004, the user authentication fails, the cloud print service 321 notifies the OS 313 of the client terminal 101 of the authentication error (S3006).

The OS 313 of the client terminal 101 aborts the process on the basis of the received authentication error information (S3007). The OS 313 terminates the process described in FIG. 3.

If the client terminal 101 has already held an access token, the processing performed by the OS 313 of the client terminal 101 proceeds to S3008 to search for a printer registered to the cloud print service 321 and a printer connected to the network 107.

The OS 313 of the client terminal 101 attaches an access token to an acquisition request for acquiring printer information registered to the cloud print service 321 and sends the acquisition request (S3008). In FIG. 3, the acquisition request in S3008 is labeled as “printer search.”

The cloud print service 321 identifies a tenant ID to which the user belongs on the basis of the access token attached to the acquisition request and generates a list of printers associated with the tenant ID to which the user belongs.

The OS 313 of the client terminal 101 acquires the list of printers generated by the cloud print service 321 and the device identification information of each of the printers (S3009).

The OS 313 displays the list of printers on the client terminal 101 on the basis of the printer information acquired from the cloud print service 321 and the printer information detected through the search of the network 107. A list 402 illustrated in FIG. 4A is a list of the printer information received from the cloud print service 321 and printers that can be searched for in the local network. FIG. 4A illustrates an example of the displayed list of printers detected by printer search. The printers labeled with “Printer001” and “Printer002” are printers registered to the cloud print service. The printer labeled with “Printer003” is a printer connected to the same network as the client terminal 101. At this stage, the icon images prestored by the OS 313 are displayed for all the printers.

Subsequently, the user selects, from among the displayed printers, the printer information of the printer that they want to register to the client terminal 101. The OS 313 sends, to the cloud print service 321, a request for the capability information of the selected cloud print-enabled printer 104 (S3010). At this time, the OS 313 determines which attributes to inquire about.

The cloud print service 321 responds to the OS 313 about the capability information of the cloud print-enabled printer 104 (S3011). The capability information of the cloud print-enabled printer 104 may be the capability information acquired at the time of printer registration or the latest capability information acquired from the cloud print-enabled printer 104 at the time of the inquiry from the OS 313.

If the cloud print service 321 does not store the capability information for the attribute inquired about by the OS 313 of the client terminal 101, the cloud print service 321 does not respond to the OS 313.

Subsequently, the OS 313 starts installing the cloud printer driver 311 that generates the print data to be sent to the printer selected by the user.

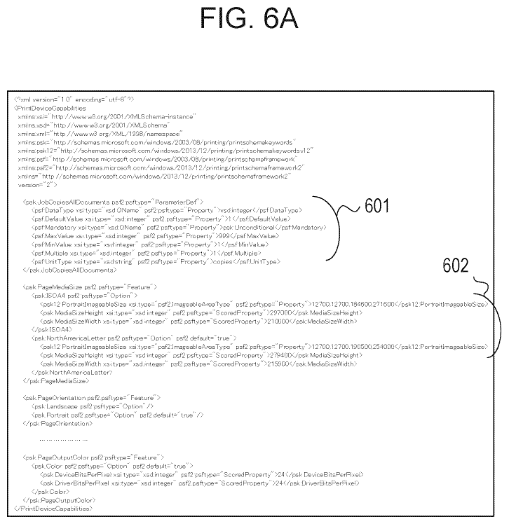

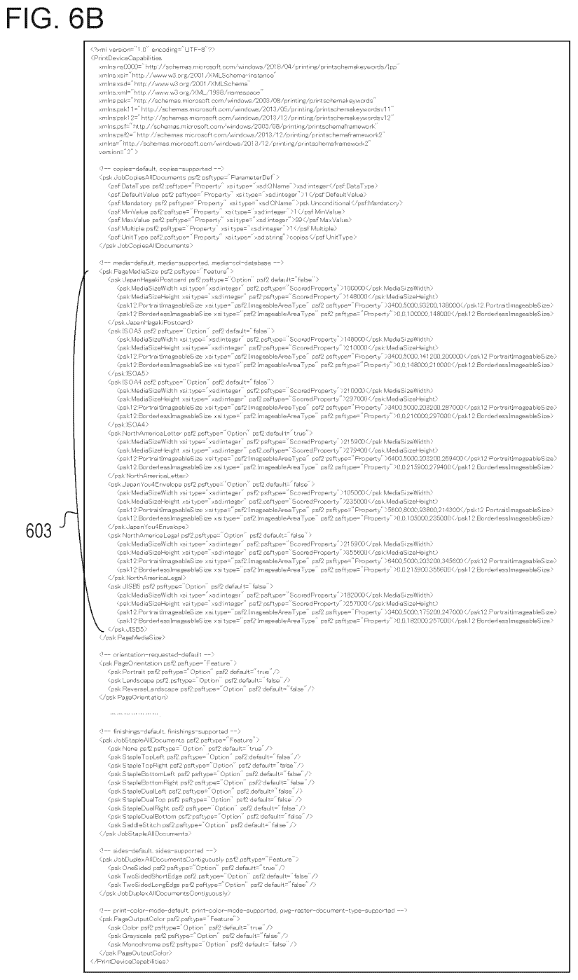

The OS 313 generates a print queue for the cloud printer driver 311 having basic device capability information that is bundled with the OS 313 (S3012). As used herein, the term “device capability information” refers to definition information required to generate print setting capability information of a printer driver, such as PrintDeviceCapabilites (PDC) written in XML. FIG. 6A illustrates an example of device capability information bundled with the OS 313. Capability information 601 is information regarding the number of copies. In this case, the capability information 601 indicates that the minimum number of copies is 1, and the maximum number is 999. Capability information 602 is information regarding the paper size. “Feature” is a function name. “Option” indicates the information regarding options that can be selected for the function. In this case, “Option” indicates that one of two paper sizes “A4” and “LETTER” can be selected. The information is associated with a print queue and is managed by the OS 313.

The OS 313 then updates the device capability information that configures the cloud printer driver 311 by using the capability information acquired from the cloud print service 321. FIG. 6B illustrates an example of the device capability information updated using the capability information acquired from the cloud print service 321. Information 603 indicates the updated paper size. “Option” other than “A4” and “LETTER” is added to “PageMediaSize” as a paper size that can be printed by the cloud print-enabled printer 104. The OS 313 registers the HWID and the device capability information of the printer and the identification information of the printer driver to be used in association with the print queue.

As described above, the installation of the cloud printer Driver 311 is completed.

The OS 313 then starts an installation process of the application that is associated with the printer and that enhances the functionality of the cloud printer driver 311.

The OS 313 first performs the process of adding additive identification information to the device identification information. This process is necessary when acquiring the extended setup information file 700 for the online support server 105. The additive identification information can be a character string that differs from the normal device identification information.

According to the present embodiment, to distinguish the application from applications for other devices, the OS 313 adds, to the device identification information, the additive identification information (“PrinterApp_”) indicating that the application corresponds to the printer.

Note that “PrinterApp_” is only an example, and another character string, numbers, or symbols may be used.

As a result, for example, if the device identification information of the cloud print-enabled printer 104 is “device001”, the device identification information after the process of adding additive identification information is “PrinterApp_device001”.

Subsequently, the OS 313 sends a search request to the online support service 351 to search for the extended setup information file (Exinf) 700 (S3013). The OS 313 sends, to the online support service 351, the device identification information having the additive identification information added thereto.

If the online support service 351 has the extended setup information file 700 containing the target device identification information, the online support service 351 sends the extended setup information file (Exinf) 700 to the OS 313 (S3014). Furthermore, in S3014, the online support service 351 sends an icon image corresponding to the extended setup information file to the client terminal 101.

FIGS. 7A and 7B illustrate an example of the extended setup information file 700 containing the device identification information that satisfies the condition “the additive identification information is added to the device identification information of a cloud print-enabled printer” in the process of adding the additive identification information.

The extended setup information file 700 consists of sections and entries. The section includes the system definition for the device. In a version section 707, the version information of the extended setup information file 700 is described. In a model section 708, the device identification information of a printer corresponding to the extended setup information file 700 is described.

An entry describes a default value and a DDL that are associated with each section.

Application identification information 701 indicates the application identification information of the print setting extension application corresponding to the extended setup information file 700.

The device identification information 702 indicates the device identification information of the device corresponding to the extended setup information file 700. In the present example, the device identification information 702 contains the device identification information after the additive identification information “PrinterApp_” is added. The online support service 351 identifies the extended setup information file containing PrinterHardwareId (the device identification information 702) that is the same as the device identification information received from the client terminal 101.

DDInstall 703 is a section that indicates that there is additional information about the printer identified by PrinterHardwareId 701 and is a section that indicates that DeviceIconProperty is the additional information. DeviceIconProperty is information indicating that the icon image of the printer is registered to the online support service 351.

DeviceIconProperty 704 is information that indicates the file name of the icon image and the location of the icon image data in the client terminal 101 at which the image icon data is to be stored after the icon image data is acquired. “DIRID 13” is the identification information of a directory specified when the client terminal 101 stores the icon image.

As described above, by using entries of DDInstall 703 and DeviceIconProperty 704, the OS 313 describes that a file “vendor.ico” is stored in a directory named “DIRID 13” and is used as the icon image. “DIRID 13” is a directory ID number determined by the OS. The directory associated with the print queue or the directory specified by the OS may differ from the above-described directory.

FIG. 7A illustrates an example in which one icon image corresponds to one HWID device. However, a plurality of icon images may be associated with one HWID device.

For example, a single printer may support both the cloud printer driver 311 and local printer driver 314. In this case, if the same icon image is displayed when the printer driver used is the cloud printer driver 311 and when the printer driver used is the local printer driver 314, it is difficult to distinguish which printer driver is used. For this reason, according to the present embodiment, different icon images are displayed when the cloud printer driver 311 is used and when the local printer driver 314 is used.

To display different icon images for the cloud printer driver 311 and the local printer driver 314, DDInstall 703 and DeviceIconProperty 704 in the extended setup information file are changed, as illustrated in FIG. 7B.

DDInstall 705 is information written to the extended setup information file instead of DDInstall 703 illustrated in FIG. 7A. CloudDeviceIconProperty 706 and LocalDeviceIconProperty 709 are information written to the extended setup information file instead of DeviceIconProperty 704 illustrated in FIG. 7A.

“AddProperty=CloudDeviceIconProperty” indicates the presence of an icon image to be used when a print queue using the cloud printer driver 311 is generated. CloudDeviceIconProperty 706 is a section containing information regarding an icon image in the case of using a cloud printer driver. CloudDeviceIconProperty 706 contains the information stating that the file name of the icon image is “vendor1.icon” and that the client terminal 101 stores the icon image in the directory identified by “DIRID 13”.

“AddProperty=LocalDeviceIconProperty” indicates the presence of an icon image to be used when a print queue using the local printer driver 314 is generated. LocalDevoceIconProperty 709 is a section containing information regarding an icon image in the case of using a local printer driver. LocalDevoceIconProperty 709 contains information stating that the file name of the icon image is “vendor2.icon” and that the client terminal 101 stores the icon image in the directory identified by “DIRID 13”.

Thus, by providing two entries in DDInstall, two icon images can be acquired.

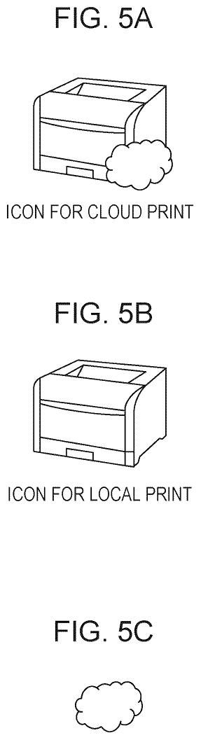

FIGS. 5A to 5C illustrate an example of the icon images acquired using the extended setup information file 700.

FIG. 5A illustrates an icon image associated with a print queue that uses the cloud printer driver 311. That is, FIG. 5A illustrates an image corresponding to “vendor1.ico” in FIG. 7B. In FIG. 5A, a cloud image is superimposed on a printer image so that it can be seen that the cloud print service 321 is used.

FIG. 5B illustrates an icon image associated with a print queue that uses the local printer driver 314. FIG. 5B illustrates an image corresponding to “vendor2.ico” in FIG. 7B. Since the local printer driver 314 directly communicates with the printer and does not use the cloud print service 321, the icon image is a printer image without a cloud image.

The above-described method for specifying icons is only an example, and any method that can acquire icon images using an extended setup information file may be used.

As described above, the online support service 351 provides an icon image to the client terminal 101 along with the extended setup information file. This enables the client terminal 101 to display the icon image corresponding to the printer used for printing.

Referring back to FIG. 3, the OS 313 installs the extended setup information (S3015). In S3015, the OS 313 installs the extended setup information file (Exinf) by reading the information contained in the extended setup information file and writing the read information to the registry.

Subsequently, the OS 313 stores the icon image acquired from the online support service 351 in the directory specified in the extended setup information file. If a plurality of icon images are specified in the extended setup information file, the plurality of icon images are stored in the directory specified in the extended setup information file.

After being downloaded, the icon image is stored in the directory specified in the extended setup information file 700. However, the directory specified in the extended setup information file may be in an area that the print setting extension application 312 cannot access.

Accordingly, according to the present embodiment, the OS 313 further stores the stored icon image in a predetermined directory. An example of the predetermined directory is QueuePropertyBag (not illustrated). The QueuePropertyBag is a data store provided by the architecture of Windows for drivers and applications to define properties or a data BLOB (Binary Large Object) for read-only use.

However, in this case, any storing technique can be used. For example, the icon images may be stored for each of the extended setup information pieces without being sorted by queue and, alternatively, when a plurality of the icon images are acquired, each of the icon images may be stored in any area. This enables the print setting extension application 312 to use the icon image acquired when the extended setup information file 700 is installed.

Subsequently, the OS 313 sends, to an application management service 331, a request for acquiring an application having an application ID that is the same as the application ID identified from the extended setup information file 700 (S3017).

If the application management service 331 stores the requested print setting extension application corresponding to the application ID, the application management service 331 returns the print setting extension application 312 to the client terminal 101 (S3018). The print setting extension application 312 sent in S3018 is an application identified by the application ID.

The OS 313 installs the acquired print setting extension application 312 in association with the print queue for the client (S3019). More specifically, the application ID is stored in the registry of the OS 313 as information regarding the print queue. When the generated print queue is invoked, the OS 313 uses the information to activate the installed print setting extension application 312.

If the application management service 331 does not store the requested print setting extension application corresponding to the application ID, the OS 313 aborts the application installation process corresponding to the requested application ID (S3020).

The processing up to S3020 is the processing related to installation of the print setting extension application 312.

The OS 313 displays the printer name and icon image of the newly registered print queue (S3021). At this time, the OS 313 displays the icon image stored in the directory specified in the extended setup information file 700 in association with the print queue.

The sequence of processes for registering the cloud print-enabled printer 104 to the cloud print service 321, generating a print queue to use the cloud print service 321 on the client terminal 101, and installing the print setting extension application 312 has been described above.

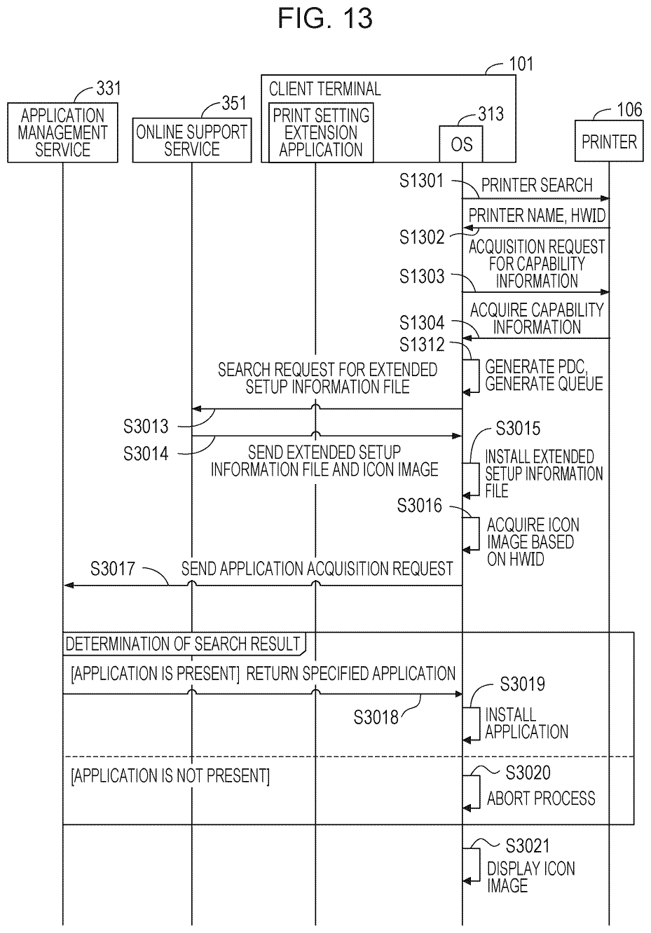

The process of installing the local printer driver 314 and installing the print setting extension application 312 is described below with reference to FIG. 13. In FIG. 13, the processes that are the same as in FIG. 3 are identified by the same reference numerals.

In S1301, the OS 313 searches for a printer connected to the network 107. In S1302, the printer 106 responds to the search query sent by the OS 313.

The OS 313 displays a list of the printers that responded and then receives selection of a printer from the user. In S1303, the OS 313 sends a capability information acquisition request to the printer selected by the user. In S1303, the OS 313 inquires about the capability information of the printer 106 using the Get-Printer-Attributes operation defined in IPP. In S1304, the printer 106 responds with the capability information. In S1305, the OS 313 installs the local printer driver 314 and generates a print queue in association with the local printer driver 314 and the device identification information and capability information of the printer 106.

The subsequent processes are the same as in FIG. 3, and the acquisition of an icon image and the like is also the same as when the cloud printer driver 311 is used.

In FIG. 1 of the present embodiment, the cloud print-enabled printer 104 and the printer 106 are illustrated as different printers. The cloud print-enabled printer 104 may be capable of printing print data generated by the local printer driver 314. For example, assume that the client terminal 101 and the cloud print-enabled printer 104 are connected to the same network. When the client terminal 101 performs printer search using the search function of the OS, the cloud print-enabled printer 104 is detected. When the user selects the cloud print-enabled printer 104 from the search result, the OS generates a print queue for sending the print data generated by the local printer driver 314 to the cloud print-enabled printer 104 without using the cloud print service 321. The process of generating the print queue and installing the print setting extension application 312 is the same as in FIG. 13.

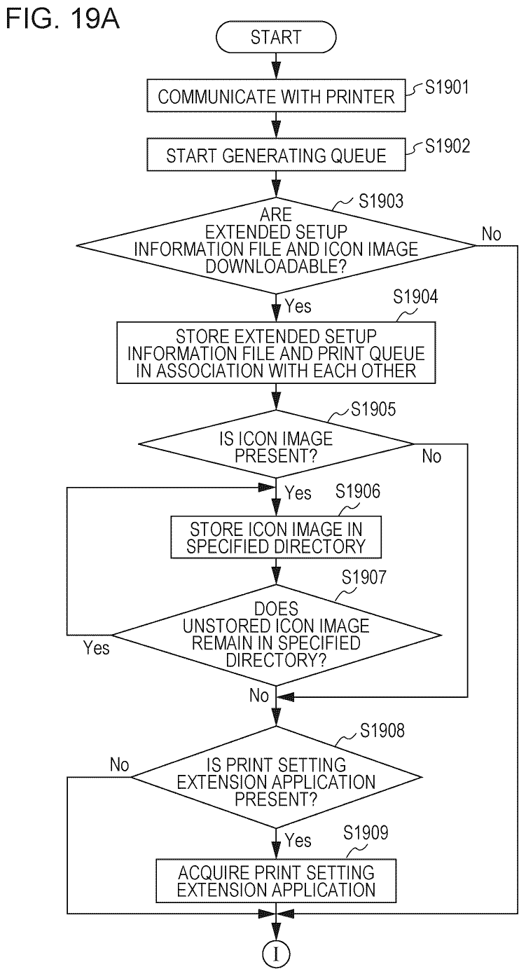

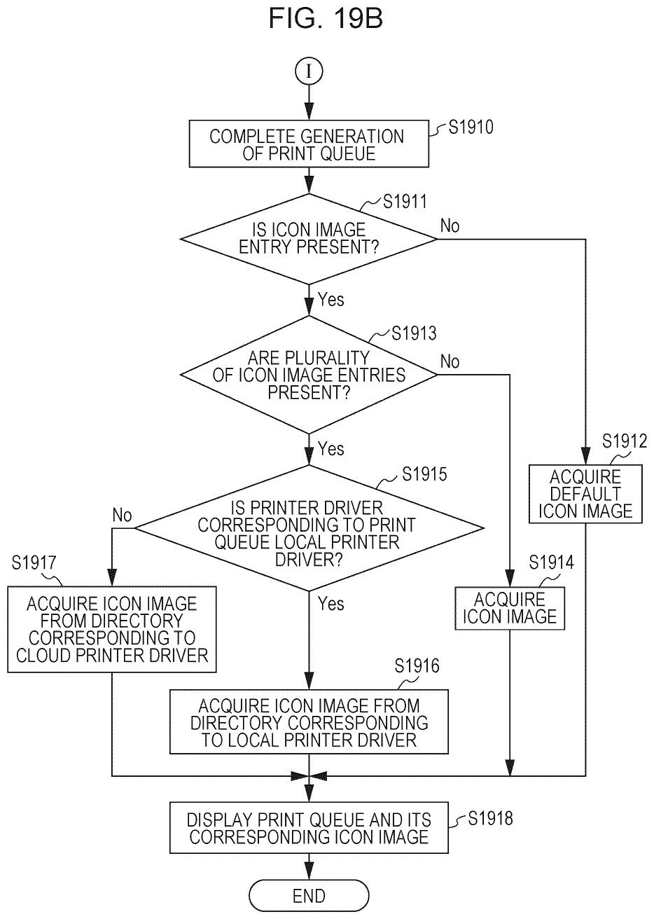

The process performed by the OS 313 to generate a print queue is described with reference to FIGS. 19A and 19B.

The processing illustrated in FIGS. 19A and 19B is performed by the CPU 212 executing the program of the OS 313. In addition, the processing illustrated in FIGS. 19A and 19B is performed when the client terminal 101 receives an instruction to select a printer from among the printers detected in the search performed in response to the selection of the object 401 in FIG. 4A. In this case, it is assumed that the printer 106 is selected.

The CPU 212 communicates with the printer 106 selected by the user to acquire information regarding the printer 106 (S1901). The CPU 212 acquires the device identification information and the capability information from the printer 106 in accordance with the specifications of the OS 313. If the printer selected by the user is a printer registered to the cloud print service 321, the CPU 212 communicates with the cloud print service 321 to acquire the information regarding the printer.

The CPU 212 starts a print queue generation process (S1902). The CPU 212 determines whether the extended setup information file can be acquired (S1903).

The CPU 212 sends the device identification information and additive information acquired in S1901 to the online support server 105. Upon receiving an extended setup information file from the online support server 105, the CPU 212 performs the process described in S1904. If the extended setup information file has not received from the online support server 105, the CPU 212 proceeds to S1910. If an icon image is registered to the online support server 105 together with the extended setup information file, the CPU 212 receives the icon image together with the extended setup information file at the timing of S1903.

The CPU 212 stores the received extended setup information file and the print queue in association with each other (S1904).

The CPU 212 refers to the acquired extended setup information file and determines whether the icon image is present (S1905). In S1905, the CPU 212 determines whether the icon image is present on the basis of whether the extended setup information file contains the DDInstall section. If the CPU 212 determines that no icon image is present, the CPU 212 proceeds to S1908. If the icon image is present, the CPU 212 performs the process described in S1906. The CPU 212 stores the icon image specified in the extended setup information file in the directory specified in the extended setup information file (S1906). The CPU 212 determines whether an unstored icon image remains in the directory (S1907). The CPU 212 refers to the DDInstall section in the extended setup information file to determine whether any unprocessed entry remains. If an unprocessed entry remains, the CPU 212 returns to S1906. If no unprocessed entry remains, the CPU 212 proceeds to S1908.

The CPU 212 determines whether a print setting extension application corresponding to the printer 106 is present (S1908). The CPU 212 determines whether PackageFamilyName is contained in the extended setup information file. If PackageFamilyName is contained, the CPU 212 determines that the print setting extension application 312 is present and performs the process described in S1909. If PackageFamilyName is not contained, the CPU 212 determines that no print setting extension application 312 is present, and the CPU 212 proceeds to S1910.

The CPU 212 acquires the print setting extension application 312 from the application management server 103 (S1909). The CPU 212 sends, to the application management server 103, the identification information contained in PackageFamilyName of the extended setup information file. Thereafter, the CPU 212 acquires, from the application management server 103, the print setting extension application 312 identified by the sent identification information and installs the print setting extension application 312. The CPU 212 stores the identification information of the print setting extension application 312 in association with the print queue. At this time, the client terminal 101 may have already stored the print setting extension application 312 of the identification information contained in the extended setup information file. In this case, the CPU 212 need not acquire the print setting extension application 312 from the application management server 103. The CPU 212 stores the identification information of the print setting extension application and the print queue in association with each other and terminates the process described in S1909.

The CPU 212 completes the print queue generation process (S1910). In the subsequent steps, the OS 313 performs processes for displaying, on the screen, the information regarding the print queue generated by the OS 313.

The CPU 212 determines whether the extended setup information file corresponding to the generated print queue contains a section related to an icon image (S1911). The CPU 212 determines whether the section related to an icon image is present on the basis of the presence or absence of the DDInstall section in the extended setup information file. If the DDInstall section is not present, the CPU 212 proceeds to S1912.

The CPU 212 acquires a default icon image prestored by the OS 313 (S1912).

The CPU 212 determines whether a plurality of icon image entries are present (S1913). The CPU 212 refers to the number of entries in the DDInstall section in the extended setup information file and makes the determination in S1913. If only one entry is present, the CPU 212 performs the process described in S1914. If a plurality of entries are present, the CPU 212 performs the process described in S1915.

The CPU 212 acquires the icon image in accordance with the information in the extended setup information file (S1914). The CPU 212 refers to the entry in the DeviceIconProperty section of the extended setup information file to identify the directory in which the icon image is stored and the file name of the icon image. The CPU 212 acquires the icon image having the identified file name from the identified directory.

The CPU 212 determines whether the printer driver associated with the print queue is a local printer driver (S1915). If the printer driver is a local printer driver, the CPU 212 performs the process described in S1916. However, if the printer driver associated with the print queue is a cloud printer driver, the CPU 212 performs the process described in S1917.

The CPU 212 acquires the icon image corresponding to the local printer driver (S1916). The CPU 212 refers to the entry in LocalDeviceIconProperty in the extended setup information file to identify the directory where the icon image is stored and the file name of the icon image. The CPU 212 acquires the icon image having the identified file name from the identified directory.

The CPU 212 acquires an icon image corresponding to the cloud printer driver (S1917). The CPU 212 refers to the entry of CloudDeviceIconProperty in the extended setup information file to identify the directory where the icon image is stored and the file name of the icon image. The CPU 212 acquires the icon image having the identified file name from the identified directory.

The CPU 212 displays the name of the generated print queue and the acquired icon image (S1918).

The above-described processing is performed by the OS 313 during print queue generation.

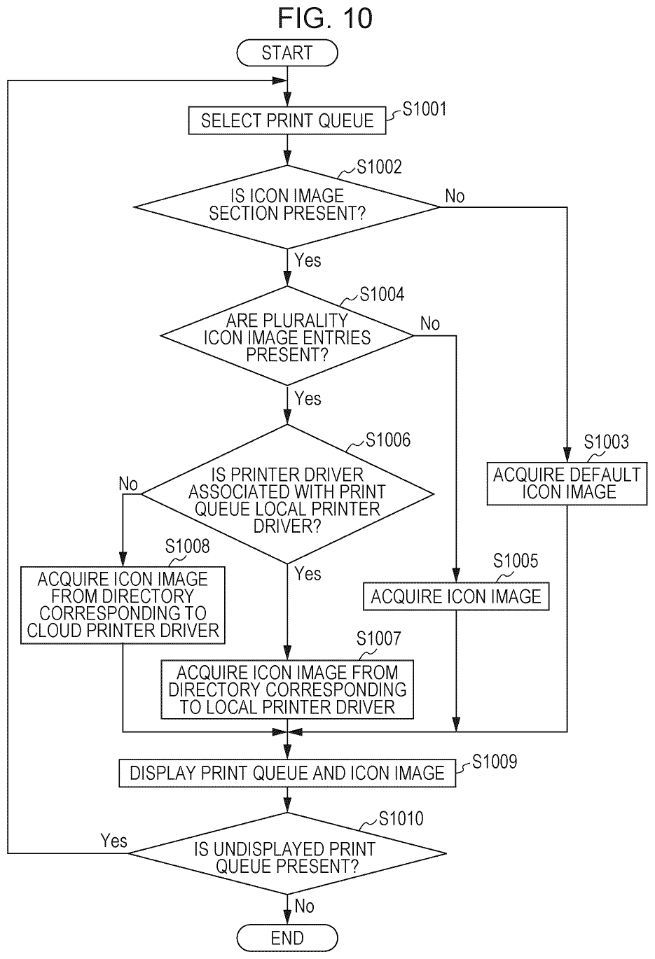

An example of the processing performed by the OS 313 to display the list of print queues illustrated in FIG. 4B is described below with reference to FIG. 10. The processing illustrated in FIG. 10 is performed when the OS 313 receives an instruction to display the list of print queues registered to the OS 313. By performing the processing illustrated in FIG. 10, the OS 313 can display a print queue in association with an icon image.

The processing illustrated in FIG. 10 is performed by the CPU 212 executing the program in the OS 313.

The CPU 212 selects one of the registered print queues (S1001). The CPU 212 refers to the extended setup information file corresponding to the selected print queue and determines whether a section indicating an icon image is present (S1002). For example, in S1002, the CPU 212 determines whether the extended setup information file contains a “DDInstall” section.

If a section corresponding to the icon image is present, the CPU 212 proceeds to S1004. If a section corresponding to the icon image is not present, the CPU 212 performs the process described in S1003.

The CPU 212 acquires a default icon image that the OS 313 can use regardless of the type of printer (S1003). The default icon image is, for example, the icon image illustrated in FIG. 4A.

The CPU 212 determines whether a plurality of entries corresponding to icon images are present in the extended setup information file corresponding to the selected print queue (S1004). For example, in S1004, the CPU 212 determines whether a plurality of entries are present in the “DDInstall” section. If only one entry is present, the CPU 212 performs the process described in S1005. If a plurality of entries are present, the CPU 212 performs the process described in S1006.

The CPU 212 acquires the icon image from the directory specified in the extended setup information file (S1005). The case where only one entry is present in DDInstall is represented by the extended setup information file illustrated in FIG. 7A. The CPU 212 refers to the DeviceIconProperty section of the extended setup information file to identify from which directory the icon image is to be acquired. The CPU 212 acquires, from the identified directory, the file specified in the extended setup information file.

The CPU 212 determines whether the printer driver associated with the selected print queue is a local printer driver (S1006). If the printer driver associated with the print queue is a local printer driver, the CPU 212 performs the process described in S1007. If the printer driver associated with the print queue is a cloud printer driver, the CPU 212 performs the process described in S1008.

The CPU 212 acquires the icon image corresponding to the local printer driver (S1007). The CPU 212 identifies, from DDInstall in the extended setup information file, the section information containing the directory in which the icon image used for the print queue of the local printer driver is stored and the file name. The CPU 212 refers to the entry in the identified section and identifies the directory in which the icon image is stored. The CPU 212 acquires the file that is stored in the identified directory and that has the file name specified in the extended setup information file. Through the above-described processing, the icon image used when the local printer driver is used is acquired.

The CPU 212 acquires the icon image corresponding to the cloud printer driver (S1008). The CPU 212 identifies, from DDInstall in the extended setup information file, the section information containing the directory in which the icon image used for the print queue of the cloud printer driver is stored and the file name. The CPU 212 acquires the file that is stored in the identified directory and that has the file name specified in the extended setup information file. Through the above-described processing, the icon image used when the cloud printer driver is used is acquired.

The CPU 212 displays the name of the selected print queue in association with the acquired icon image (S1009). Then, the CPU 212 determines whether any print queue is present that is registered to the OS 313 and that has not yet been displayed (S1010). If an undisplayed print queue is present, the processing returns to S1001. When the icon images for all the print queues registered to the OS 313 are displayed, the processing described in the flowchart ends.

As described above, the processing up to registration of the print queue in the OS 313 is performed.

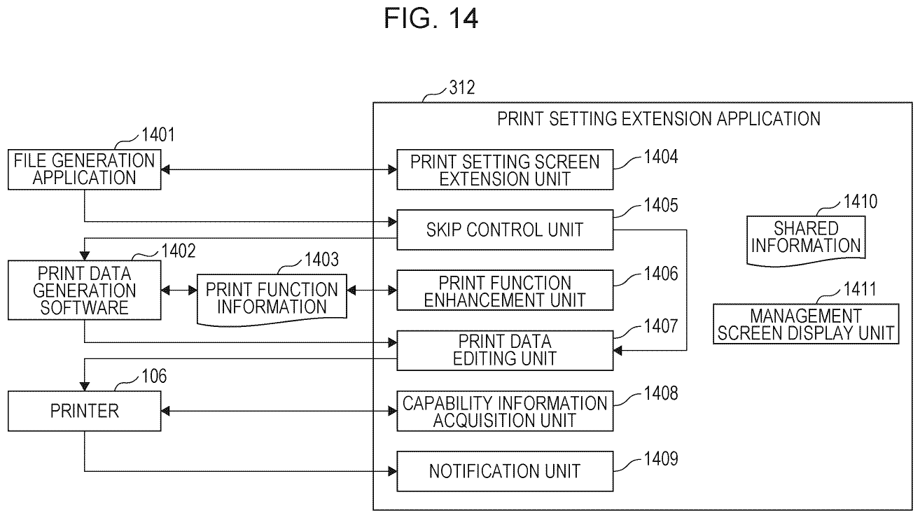

FIG. 14 is a schematic illustration of a printing process using the print setting extension application 312 that is installed in the client terminal 101 in the above-described sequence illustrated in FIG. 3 or 13.

The print setting extension application 312 includes software modules 1404 to 1409 and shared information 1410. Each of the modules is described below.

A file generation application 1401 is an application that generates, for example, document data and presentation data and works on a spreadsheet. The file generation application 1401 is installed in the client terminal 101 to output image data to be printed.

A print data generation software 1402 is software provided by the OS 313 of the client terminal 101. The print data generation software 1402 performs a process of converting print setting values into the attribute values defined by a predetermined protocol and a process of converting image data output by the file generation application 1401 to data in a predetermined format. An example of the predefined protocol is InternetPrintingProtocol. An example of the predetermined format is a portable document format (PDF) or PWG-Raster. Print function information 1403 is the device capability information of the cloud print-enabled printer 104 or the printer 106. The print function information 1403 is also referred to as “PDC”. The OS 313 performs the Get-Printer-Attributes operation defined by IPP to acquire the functions (attribute information) and setting values (attribute values) that can be used by the printer 106. The OS 313 writes the acquired attribute information and attribute values, which the OS 313 can interpret, into the print function information 1403. Print settings and capability information based on the print function information 1403 are provided to the file generation application 1401 and the print setting extension application 312.

In the description below, a printer connected to the client terminal 101 is the printer 106. However, the cloud print server 102 may be connected instead of the printer 106.

The print setting extension application 312 provides four major functions, that is, expansion of print function information 1403, display of print setting screens, editing of print data, and display management screens of a printer.

The expansion of the print function information 1403 is first described. The capability information acquisition unit 1408 communicates with the printer 106 to acquire the capability information of the printer 106. The capability information acquisition unit 1408 uses the Get-Printer-Attributes operation to acquire the capability information from the printer 106. Although the OS 313 also has a function to acquire the capability information from the printer 106, the capability information acquisition unit 1408 can acquire the capability information for setting items and setting values that the OS 313 does not acquire. For example, the capability information acquisition unit 1408 acquires the capability information regarding a user-defined paper size that the user has registered to the printer and regarding staple-free binding, which binds paper without using a staple. The capability information acquired by the capability information acquisition unit 1408 is written into the print function information 1403 by the print function enhancement unit 1406.

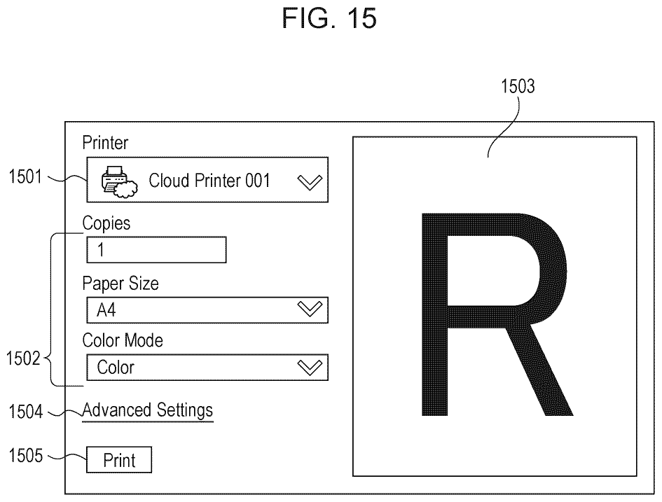

The display of a print setting screen by the print setting extension application 312 is described below. For example, the file generation application 1401 displays the print setting screen illustrated in FIG. 15.

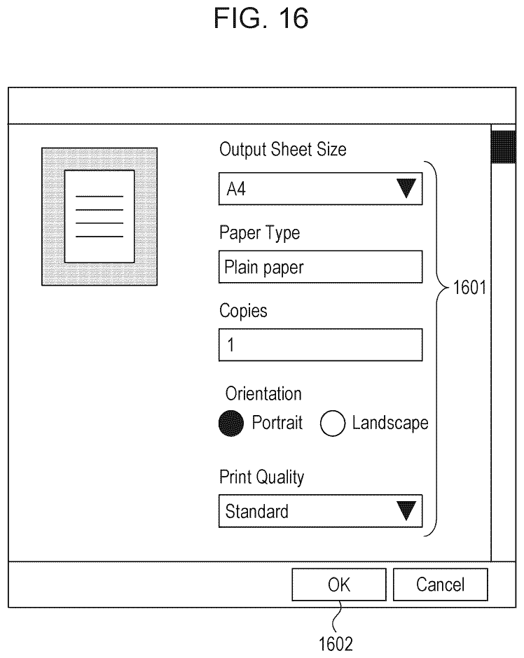

A field 1501 is a field used to select the print queue to be used for printing. A field 1502 is a field displayed by the file generation application 1401 on the basis of the capability information provided by the OS 313 and receives settings related to the number of copies, paper size, and color mode. The field 1502 is displayed using PrintCapabilities that is generated on the basis of the print function information 1403. A field 1503 displays a preview image of a file to be output by the file generation application 1401. An object 1504 is an object to activate the print setting extension application 312 corresponding to the print queue selected in the field 1501. When the user selects the field 1504, a start instruction is input to the print setting extension application 312. The print setting screen extension unit 1404 displays a print setting screen illustrated in FIG. 16.

The print setting screen extension unit 1404 acquires PrintCapabilities and PrintTicket based on the print function information 1403 from the OS 313 and displays the print setting screen illustrated in FIG. 16. PrintCapabilities contains the function that can be set and the setting value. PrintTicket contains a setting value that is set for each of functions. A field 1601 is displayed on the basis of the PrintCapabilities and PrintTicket acquired from the OS 313. The print setting screen illustrated in FIG. 16 is scrollable. By scrolling the screen, objects for setting items that are hidden are displayed. The print setting screen illustrated in FIG. 16 enables setting of values for setting items that cannot be set in the print setting screen provided by the file generation application 1401 or the OS 313. Examples of the setting items that cannot be set in the print setting screen provided by the file generation application 1401 or the OS 313 include the setting items for bookbinding printing and staple-free binding.

An object 1602 is an object for the user to finally determine the print settings set via the print setting screen provided by the print setting screen extension unit 1404 and for closing the displayed print setting screen.

When the object 1602 is selected, the print setting screen extension unit 1404 writes the setting values set via the screen illustrated in FIG. 16 into PrintTicket. As described above, the processing related to display of the print setting screen is performed.

Editing of print data is described below. When an object 1505 in FIG. 15 is selected, the file generation application 1401 outputs the image data to be printed. The file generation application 1401 outputs the data in GDI format or XPS format.

When the data output by the file generation application 1401 is in GDI format, the OS 313 converts the data output from the file generation application 1401 to intermediate data in XPS format. The OS 313 activates a skip control unit 1405. The skip control unit 1405 sends, to the print data generation software 1402, a flag indicating whether the PDL data generation by the print data generation software 1402 is to be performed.

If the print data generation software 1402 receives an instruction to skip the PDL data generation process, the print data generation software 1402 converts the setting values written to the PrintTicket into the attribute values defined by IPP and sends the converted attribute values and the intermediate data to a print data editing unit 1407. If the print data generation software 1402 does not receive an instruction to skip the PDL data generation process, the print data generation software 1402 converts the intermediate data into PDL data. The converted PDL data and information converted from PrintTicket into the attribute value defined by IPP are sent to the print data editing unit 1407.

The print data editing unit 1407 edits the PDL data received from the print data generation software 1402. As used herein, the term “editing of PDL data” refers to a layout process to merge multiple page image data to one page or a process to add an image or a character string specified by the user to image data. In addition, the print data editing unit 1407 converts the setting values that are included in PrintTicket acquired from the OS 313 and that are not converted into the attribute values defined by IPP by the print data generation software 1402 into the attribute values defined by IPP.

If the skip control unit 1405 instructs the print data generation software 1402 to skip the PDL data generation process, the print data editing unit 1407 converts the intermediate data into PDL data. The converted PDL data is sent to the printer 106 together with the attribute values converted by the print data generation software 1402 and the print data editing unit 1407. As described above, the processing related to print data editing and transmission is performed.

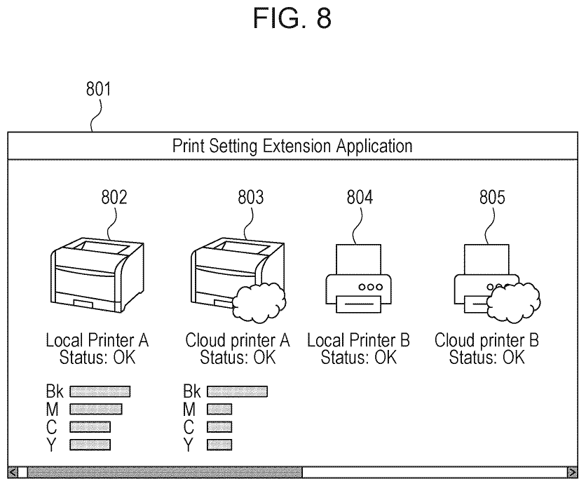

Display of a management screen of the printer is described below. The management screen of a printer is displayed in the following two situations: (1) where the OS 313 receives a notification from the printer 106, the user selects a pop-up window displayed by the OS 313, and the OS 313 sends a notification to the notification unit 1409 in accordance with the selection, and (2) where the print setting extension application 312 is instructed to start through the home screen provided by the OS 313. In the latter case, a management screen display unit 1411 operates to display the management screen illustrated in FIG. 8. FIG. 8 illustrates the print queues that are stored in association with the print setting extension application 312. From the screen illustrated in FIG. 8, the user can check the status information regarding the consumable status of each of the printers and check whether the printer is ready to print or not. Furthermore, when one of the print queues is selected, a device setting screen for the corresponding printer may be displayed. According to the present embodiment, the management screen display unit 1411 displays an image corresponding to the printer associated with the print queue by using an icon image acquired from the online support service.

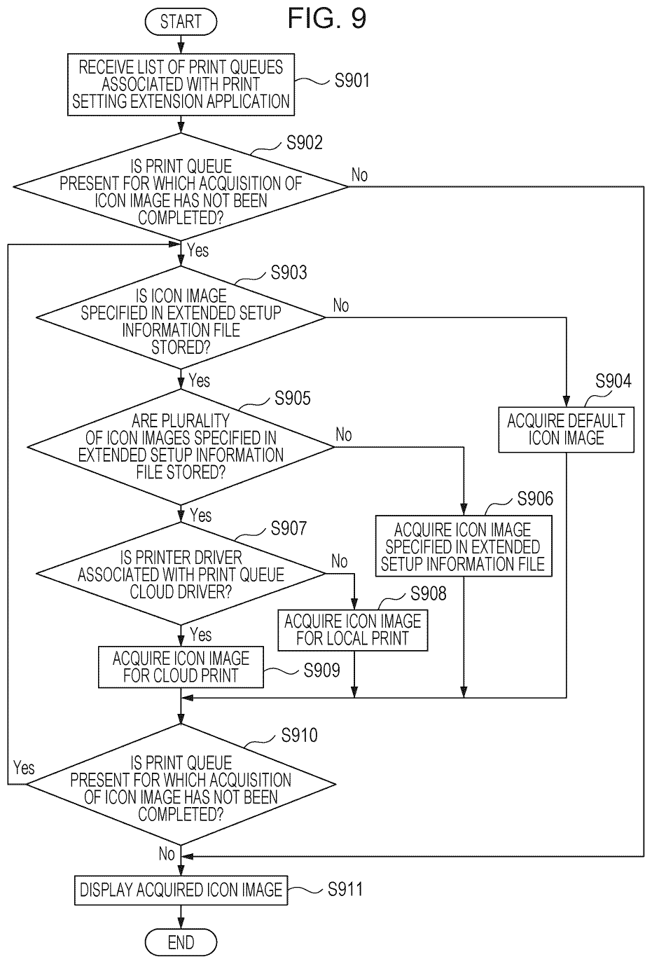

FIG. 9 is a flowchart of the processing performed by the print setting extension application 312 to display an icon image acquired from the online support service 351. The processing described by the flowchart in FIG. 9 is performed by the CPU 212 executing a program provided by the print setting extension application 312.

The processing illustrated in FIG. 9 is started and performed by the management screen display unit 1411 initiated in response to activation of the print setting extension application 312 by user operation. The user activates the print setting extension application 312 by selecting the print setting extension application 312 from a menu screen provided by the OS 313.

The CPU 212 receives, from the OS 313, a list of print queues stored in association with the print setting extension application 312 (S901). The list of print queues includes the names of the print queues.

The CPU 212 determines whether a print queue is present that is included in the list of print queues received from the OS 313 and for which acquisition of the icon image has not been completed (S902). The CPU 212 make the determination in S902 on the basis of the information regarding the print queues associated with the print queues in the print queue list. If acquisition of the icon image has been completed for all of the print queues acquired from the OS 313, the CPU 212 proceeds to S911 described below. If a print queue is present for which acquisition of the icon image has not been completed, the CPU 212 proceeds to S903.

The CPU 212 selects one of print queues for which the icon image have not been acquired, refers to the extended setup information file for the selected print queue, and determine whether the icon image is stored (S903). The CPU 212 determines whether the icon image specified in the extended setup information file is stored in QueuePropertyBag or the directory in which an icon image is stored. If DeviceIconProperty is contained in the extended setup information file, the CPU 212 determines that the icon image is stored. If DeviceIconProperty is not contained in the extended setup information file, the CPU 212 determines that the icon image is not stored. If, in S903, the CPU 212 determines that the icon image is not stored, the CPU 212 performs the process described in S904.

The CPU 212 acquires a default icon image provided by the OS 313 (S904). The CPU 212 uses an API provided by the OS 313 to acquire the default icon image provided by the OS 313 and stores the default icon image in an area that can be referenced by the print setting extension application 312 in association with the print queue. According to the present embodiment, if a printer-specific icon image is not present, the icon image provided by the OS 313 is used. However, if a printer-specific icon image is not present, a default image prestored by the print setting extension application 312 may be acquired as the icon image and may be stored in association with the print queue.

The CPU 212 determines whether a plurality of icon images are specified in the extended setup information file (S905). The CPU 212 refers to AddProperty in DDInstall in the extended setup information file. If a plurality of DeviceIconProperty are contained as AddProperty, the CPU 212 determines that a plurality of icon images are present. If only one DeviceIconProperty is contained, the CPU 212 performs the process described in S906.

The CPU 212 acquires the icon image acquired from the online support service 351 and stores the icon image in an area accessible by the print setting extension application 312 in association with the print queue (S906). The CPU 212 acquires, from QueuePropertyBag, the icon image specified by the file name of the icon image contained in the extended setup information file. According to the present embodiment, the CPU 212 acquires the icon image from QueuePropertyBag. However, the CPU 212 may acquire the icon image from the directory in which the icon image is stored.

If the extended setup information file contains information regarding a plurality of icon images, the CPU 212 determines whether the printer driver associated with the print queue is the cloud printer driver 311 (S907).

If the printer driver associated with the print queue is not the cloud printer driver 311, the CPU 212 performs the process described in S908. The CPU 212 acquires the icon image for local print and stores the icon image in an area that can be referenced by the print setting extension application 312 (S908) in association with the print queue. The CPU 212 acquires, from QueuePropertyBag, the icon image having the file name specified by LocalDeviceIconProperty in the extended setup information file. The CPU 212 stores the acquired icon image in an area that can be referenced by the print setting extension application 312 in association with the print queue. According to the present embodiment, the icon image is read from the QueuePropertyBag. However, the icon image may be read from the directory in which the control unit 212 has stored the icon image. If the driver associated with the print queue is the local printer driver 314, the icon image representing only a printer illustrated in FIG. 5B is acquired.

If the printer driver associated with the print queue is the cloud printer driver 311, the CPU 212 performs the process described in S909. The CPU 212 acquires, from QueuePropertyBag, an icon image having the file name specified in the CloudDeviceIconProperty in the extended setup information file. The CPU 212 stores the acquired icon image in an area that can be referenced by the print setting extension application 312 in association with the print queue (S909). According to the present embodiment, the icon image is read from the QueuePropertyBag. However, the icon image may be acquired from the directory in which the CPU 212 has stored the icon image. If the driver associated with the print queue is the cloud printer driver 311, the icon image illustrated in FIG. 5A is acquired.

The CPU 212 determines whether a print queue for which acquisition of the icon image has not been completed is included in the print queue list received from the OS 313 (S910). If a print queue for which acquisition of the icon image has not been completed is included, the CPU 212 selects one of the print queues for which acquisition of the icon image has not been completed and returns the processing to S903. By repeating the processing from S903 to S910, the icon image for the print queue associated with the print setting extension application 312 can be acquired.

If no print queue for which acquisition of the icon image has not been completed is included, the CPU 212 proceeds to S911.

The CPU 212 instructs the display unit 216 to display the print queue and the icon image (S911). An example in which the print setting extension application 312 displays icon images is illustrated in a screen 801 in FIG. 8. In FIG. 8, one print setting extension application 312 is associated with four print queues.

A print queue 802 is a print queue associated with the local printer driver 314, and the icon image illustrated in FIG. 5B is displayed. A print queue 803 is a print queue associated with the cloud printer driver 311, and the icon image illustrated in FIG. 5A is displayed. By changing the image in accordance with the printer driver associated therewith, the user can easily identify which print queue is associated with which printer driver on the screen displayed by the print setting extension application 312.

Each of the print queues 804 and 805 is assigned an icon image that is assigned when any icon image cannot be acquired from the online support service 351. The icon images associated with print queues 804 and 805 are the icon images that are acquired in S904 of FIG. 9. Even when the default icon image is assigned, the icon image is changed depending on whether the printer driver associated with the print queue is the cloud printer driver 311 or the local printer driver 314. This process enables the user to check which print queue is connected to the cloud print service 321.

The icon images acquired in S904, S906, S908, or S909 may be stored, and when the print setting extension application 312 is activated next time, the determination made in S902 may be set to No. In this way, the screen may be displayed without acquiring the icon image.

With reference to FIG. 9, the processing has been described that is performed when the print setting extension application 312 is activated from the home screen provided by the OS 313. When the print setting extension application 312 is activated from a screen provided by the file generation application 1401 that generates document data, presentation data, or other data, the print setting extension application 312 may acquire the icon image. When a predetermined user operation is accepted on the screen displayed by the file generation application 1401, the processing described in FIG. 9 is performed. At this time, in S901, instead of notification of all the print queues associated with the print setting extension application 312, notification of one print queue that is selected by the file generation application 1401 is provided to the print setting extension application 312. The print setting extension application 312 performs the process in S902 and the subsequent processes for the notified one print queue.

When the print setting extension application 312 is activated from the print setting screen provided by the OS 313 instead of the file generation application 1401, the processing described in FIG. 9 may be performed. In this case, like the case where the print setting extension application 312 is activated from the file generation application 1401, one print queue selected by the OS 313 is notified to the print setting extension application 312 in S901. The print setting extension application 312 performs the process in S902 and subsequent processes for the notified one print queue.

According to the embodiment above, the case has been described where an icon image is stored in an area called QueuePropertyBag, and the print setting extension application reads and uses the icon image.

The storage location of an icon image is not limited to the location described above. For example, a storage area for each of the print queues may be provided in the storage unit 214. In this case, the CPU 212 stores the icon image acquired in S3014 of FIG. 3 in the memory area provided for each of the print queues. The print setting extension application 312 acquires the icon image from the memory area for the print queue associated with the application.

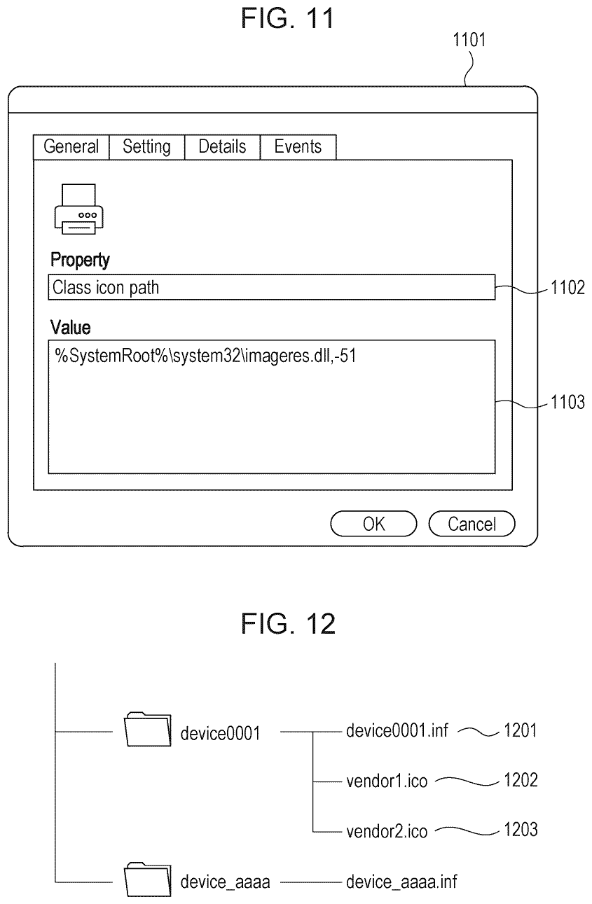

The acquired icon image may be stored in a DLL file. In this case, an API to acquire an icon image by using a print queue as an argument may be provided, and the print setting extension application 312 may acquire the icon image by using the API. Instead of using the API described above, the icon image may be acquired using an API that takes the file path where the icon image is stored as an argument. For example, suppose that the print queue information is managed as illustrated in FIG. 11. A screen 1101 illustrated in FIG. 11 displays the print queue information provided by the OS of the client terminal 101. A Property field 1102 indicates which information item about the print queue is displayed in a Value field 1103. In the present example, “Class icon Path” is displayed in the Property field 1102, indicating that the file path where the icon image is stored is displayed in the Value field 1103. The print setting extension application 312 may acquire the icon image from the location indicated by the value of Class icon Path.

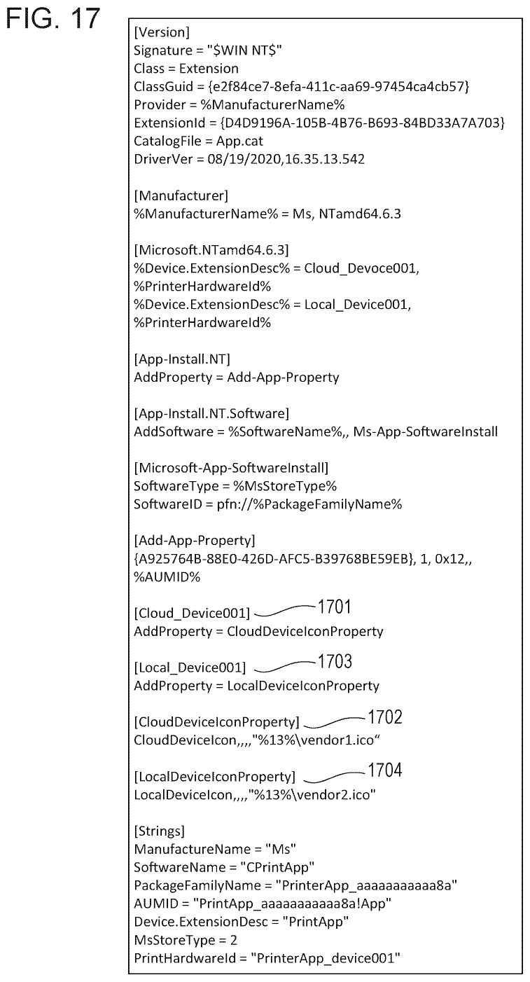

The present embodiment has been described above with reference to the example in which the icon images are acquired using the extended setup information file illustrated in FIGS. 7A and 7B. However, an example illustrated in FIG. 17 may be used as an extended setup information file. When the extended setup information file illustrated in FIG. 17 is used, additive information in accordance with the type of printer driver is added to the device identification information acquired by the OS 313 from the printer or cloud print service, and the device identification information is managed.

A technique for acquiring and displaying an icon image by using the extended setup information file illustrated in FIG. 17 is described below. The extended setup information file illustrated in FIG. 17 is used to generate a print queue for sending print data to a cloud print-enabled printer 104 via the cloud print service. Even when the information regarding the print queue is extended using the extended setup information file illustrated in FIG. 17, the processing from S3001 to S3021 of FIG. 3 is performed in substantially the same manner. Only the process for displaying an icon image is described below.

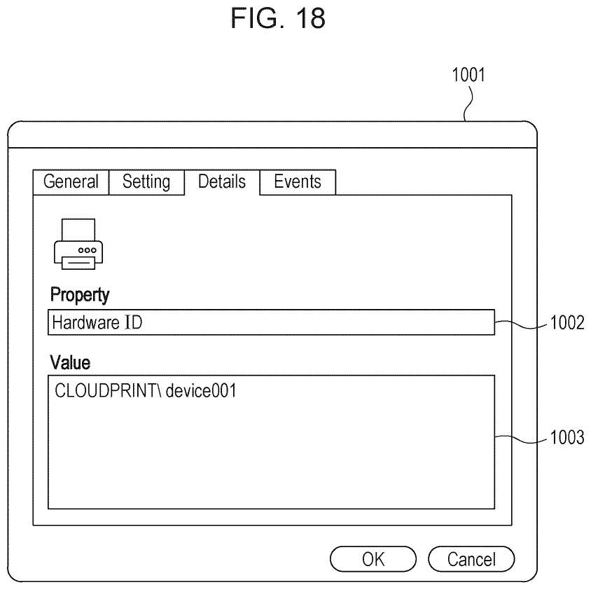

When a print queue is generated using the extended setup information file illustrated in FIG. 17, the generated print queue has property information illustrated in FIG. 18. FIG. 18 is a screen provided by the OS 313 to display the information regarding the print queue. A Property field 1002 is a field used to select the name of information item regarding the print queue. A Value field 1003 displays the value of the information item having the item name selected in the Property field 1002.

In FIG. 18, Hardware ID of the printer associated with the print queue is selected in the Property field 1002. The value in the Value field 1003 is “CLOUDPRINT\device001”. The Hardware ID of the cloud print-enabled printer 104 is “device001”. If the printer driver associated with the print queue is a cloud printer driver, “CLOUDPRINT\” is added. Similarly, if the printer driver associated with the print queue is a local printer driver, “LOCAL\” is added to the Hardware ID acquired from the printer.

The OS 313 determines whether the extended setup information file contains a section having the same name as the Value of the Hardware ID in the properties of the print queue. If a section having the same name as the Hardware ID is not contained, the OS 313 acquires a default icon image stored in advance. If a section having the same name as the Hardware ID is contained, the OS 313 refers to the entry of the section. For example, in FIG. 17, a section 1701 is the section having the same name as the Hardware ID. The OS 313 refers to the entry in the section 1701. The OS 313 then determines whether a section having the name the same as the character string specified in the entry is contained in the extended setup information file. In the present example, a section 1702 is the section having the name the same as the character string specified in the entry in the section 1701. The section 1702 indicates the directory in which the icon image used when the cloud printer driver is used is stored and the file name of the icon image. That is, the section 1702 indicates that the icon image with the file name “vendor1.ico” is stored in the directory identified by “DIRID 13”. The OS 313 refers to the information in the section 1702 and acquires an icon image from the directory indicated by the entry in the section 1702. Then, the OS 313 displays the name of the print queue and the acquired icon image.

If the selected print queue is associated with a local printer driver, the OS 313 acquires and display the icon image on the basis of the information in the sections 1703 and 1704.

As described above, according to the present embodiment, a technique has been described for the print setting extension application 312 to acquire and display an icon image to be acquired when a universal printer driver that differs from the printer driver provided by the printer vendor is installed. According to the present embodiment, the icon image is changed in accordance with the type of printer driver used, so that the user can visually identify the print queues having different functions to be used.

### Other Examples

Embodiments of the present disclosure can be achieved by supplying a program that provides one or more functions of the above-described embodiment to a system or an apparatus via a network or a recording medium and reading and executing the program by using one or more processors in a computer of a system or an apparatus. Also, embodiments of the present disclosure can be achieved by a circuit (for example, an application specific integrated circuits (ASIC)) that provides one or more functions of the above-described embodiment.

Embodiments of the present disclosure can provide a computer program for executing a user-friendly control method for controlling an information processing apparatus.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-104675, filed Jun. 27, 2023, which is hereby incorporated by reference herein in its entirety.

What is claimed is:

1. A non-transitory computer-readable recording medium storing one or more control programs including executable instructions, which when executed by a computer, cause the computer to perform a method for controlling an information processing apparatus storing a plurality of universal printer drivers, the method comprising:
receiving a plurality of icon images each identified based on identification information of a printer;
selecting one icon image from among the plurality of icon images based on a type of universal printer driver stored in association with the identification information of the printer; and
controlling displaying of the selected icon image on a display unit.

2. The non-transitory computer-readable recording medium according to claim 1, wherein in the receiving, the identification information of a printer is received from the printer, and the plurality of icon images are received from an information processing apparatus that differs from the printer.

3. The non-transitory computer-readable recording medium according to claim 1, wherein:
in the receiving, information about correspondence between each of the plurality of icon images and one of the universal printer drivers is received and,
in the selecting, the icon image based on the received information is selected.

4. The non-transitory computer-readable recording medium according to claim 1, wherein the plurality of universal printer drivers include a first universal printer driver configured to generate print data to be sent to the printer by using a cloud print service and a second universal printer driver configured to generate print data to be sent to the printer without using the cloud print service.

5. The non-transitory computer-readable recording medium according to claim 1, wherein the plurality of universal printer drivers generate image data and print settings in accordance with a predetermined protocol that are to be sent in accordance with the predetermined protocol.

6. The non-transitory computer-readable recording medium according to claim 5, wherein the predetermined protocol is Internet Printing Protocol.

7. A method for controlling an information processing apparatus storing a plurality of universal printer drivers, the method comprising:
receiving a plurality of icon images each identified based on identification information of a printer;
selecting one icon image from among the plurality of icon images based on a type of universal printer driver stored in association with the identification information of the printer; and
controlling displaying of the selected icon image on a display unit.

8. The method according to claim 7, wherein in the receiving, the identification information of the printer is received from the printer, and the plurality of icon images are received from an information processing apparatus that differs from the printer.

9. The method according to claim 7, wherein:
in the receiving, information regarding correspondence between each of the plurality of icon images and one of the universal printer drivers is received and,
in the selecting, the icon image based on the received information is selected.

10. The method according to claim 7, wherein the plurality of universal printer drivers include a first universal printer driver configured to generate print data to be sent to the printer by using a cloud print service and a second universal printer driver configured to generate print data to be sent to the printer without using the cloud print service.

11. The method according to claim 7, wherein the plurality of universal printer drivers generate image data and print settings in accordance with a predetermined protocol that are to be sent in accordance with the predetermined protocol.

12. The method according to claim 11, wherein the predetermined protocol is Internet Printing Protocol.

13. An information processing apparatus for storing a plurality of universal printer drivers, the information processing apparatus comprising:
a receiving unit configured to receive a plurality of icon images each identified based on identification information of a printer;
a selecting unit configured to select one icon image from among the plurality of icon images based on a type of universal printer driver stored in association with the identification information of the printer; and
a control unit configured to control displaying of the selected icon image on a display unit.
